(19) United States
(12) Patent Application Publication
(10) Pub. No.: US 2006/0108756 A1
(43) Pub. Date: May 25, 2006

(54) Hands-free vehicle control device

(76) Inventors: Ben Frederick Kerr, Central (HK); Neil Waldbaum, Victoria (AU)

Correspondence Address: STALLMAN & POLLOCK LLP, 353 SACRAMENTO STREET, SUITE 2200, SAN FRANCISCO, CA, 94111, US

(21) Appl. No.: 11/175,248

(22) Filed: Jul. 6, 2005

Related U.S. Application Data
(60) Provisional application No. 60/680,945, filed on May 13, 2005.
(60) Provisional application No. 60/630,473, filed on Nov. 24, 2004.

(51) Int. Cl. B62D 39/00

(52) U.S. Cl. 280/33.992

(57) ABSTRACT

An operator can be connected to a moveable vehicle used to support a person or object, via a control device including a belt and pair of control poles. The control poles each can be telescopic, or adjustable in length, and can include resilient portions allowing for flexing and shock absorption. Anchors can be attached by hand to a handle bar or other support member(s) of the vehicle. The control poles then can be attached by hand to anchors on the belt and the anchors on the handlebar. The control bars can include rotatable portions such that the device can attach to any appropriate support member. The vehicle anchors can include an adjustable member, such as a strap, that allows the anchors to fit most vehicles. The adjustability and shock absorption of the attachment device provide a level of control and comfort for the operator.

### CLAIM OF PRIORITY

This application claims benefit from U.S. Provisional Patent Application No. 60/680,945, entitled “HANDS-FREE VEHICLE CONTROL DEVICE,” filed May 13, 2005, Atty Docket No. KERR-100, as well as U.S. Provisional Patent Application No. 60/630,473, entitled “RUNN BABY,” filed Nov. 24, 2004, each of which is hereby incorporated herein by reference.

### TECHNICAL FIELD OF THE INVENTION

The present invention relates to the connection of a manually-controlled vehicle, such as a stroller or wheelchair, to an operator in order to allow for hands-free control and/or operation of the vehicle.

### BACKGROUND

Vehicles such as strollers, jog strollers, baby buggies, carriages, prams, pushers, and wheelchairs are common devices used to assist persons who may have difficulty walking, jogging, or otherwise moving from one place to another. While motorized devices exist, many other devices require manual operation, either by the passenger in the vehicle or by a secondary person, or operator, outside the vehicle. This typically involves a person positioned behind the vehicle in order to push the vehicle to a desired location. Other devices are designed to by pulled by an operator in front of the vehicle. Often, the pushing or pulling is done using handlebars or the like. In some cases, such as where the operator has to push the vehicle for a long distance, would like to move at an increased speed for exercise, or otherwise has difficulty or is uncomfortable pushing the vehicle using the handlebars, it is desirable to allow the operator to control the vehicle without requiring both hands to push the vehicle. Pushing using only a single arm can be unbalanced and uncomfortable. Allowing an operator to control the vehicle using another part of the body can free up the arms and allow for a natural, balanced movement, whether walking, jogging, or running.

One approach is to connect the operator to the vehicle through the use of a harness or attachment. A first approach disclosed by Bellinson (U.S. Pat. No. 6,098,993) allows for a person to be attached to a baby stroller via a belt secured around the waist of that person. A pair of push bars connects the person to the baby stroller through a secure connection to the belt and a loose-link clamp assembly to a horizontal handlebar portion of the baby stroller. Each clamp assembly includes a band secured to the handle of the stroller through a bolt and nut assembly. A rigid closed-loop link connects the end of the push bar to the respective band. Each link is loosely contained within bores in the respective band and push bar, allowing for a length adjustment of the push bars between the attachment to the baby stroller handle and the belt. While this approach allows for control of the baby stroller, there can be a number of drawbacks for many people. For instance, the bars are connected to the baby stroller through loose links, which cannot break away or quickly release in the case of an emergency, and which do not provide smooth control but can instead lead to a “jerkiness” of operation, as the links alternatively push, pull, or apply no pressure to the handlebar. This jerkiness can provide a level of shock that can be harmful to the passenger and/or operator. The push bars also are shown to be connected at the front of the belt, such that pressure can be applied to a stomach area of the torso of the user, which can be uncomfortable and allow for only an intermediate level of steering control. Further, such pressure is potentially dangerous to the operator, particularly for pregnant women or people with stomach problems. The secure attachment of the push bars to the belt also fails to account for operators of different sizes, who would have different waist heights with respect to the handlebar.

A later approach disclosed by Gorringe (U.S. Pat. No. 6,349,949) includes a similar harness for a baby stroller, but which allows for a releasable connection between the push bars and the respective fasteners to the handlebars. There fasteners take the form of U-bolts, straps, or bands. These fasteners can have drawbacks for certain persons, as they only allow for movement in a vertical plane. Further, these connections are significantly rigid, thereby transferring all movement of the person attached to the vehicle directly to the vehicle, which can provide an uneven movement and amount of shock inducement unto the baby stroller. Further, similar to the device of Bellinson, the push bars are connected at the front of the belt, applying pressure to a stomach area of the torso of the user, and the attachment of the push bars to the belt fails to account for operators of different sizes, who would have different waist heights with respect to the handlebar.

### BRIEF DESCRIPTION OF THE DRAWINGS

FIG. 1 is a diagram of a control device attached between an operator and a vehicle in accordance with one embodiment of the present invention.

FIG. 2 is a diagram of the control device of FIG. 1.

FIG. 3 is a diagram of a belt anchor that can be used with the control device of FIG. 1.

FIG. 4 is a diagram of a vehicle anchor that can be used with the control device of FIG. 1.

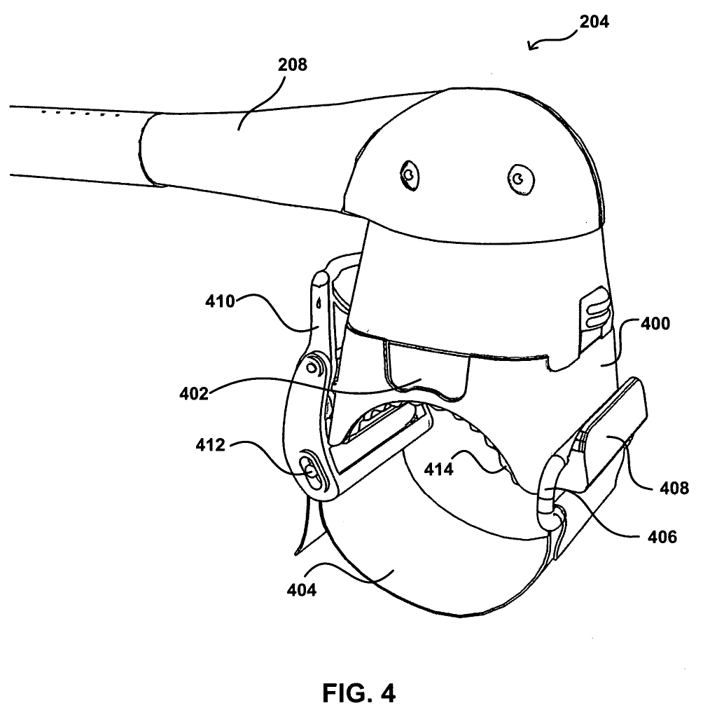

FIG. 5 is a diagram of a control pole that can be used with the control device of FIG. 1.

FIG. 6 is a diagram showing the interconnection of a control pole and a vehicle anchor in accordance with one embodiment of the present invention.

FIGS. 7(a) and (b) is each include a diagram showing the belt of FIG. 2 including a safety ripcord.

Reference numbers are carried over between figures where appropriate for ease of explanation and understanding. Such use should not be deemed to limit the scope of the invention or the number of combinations or embodiments included therein.

### DETAILED DESCRIPTION

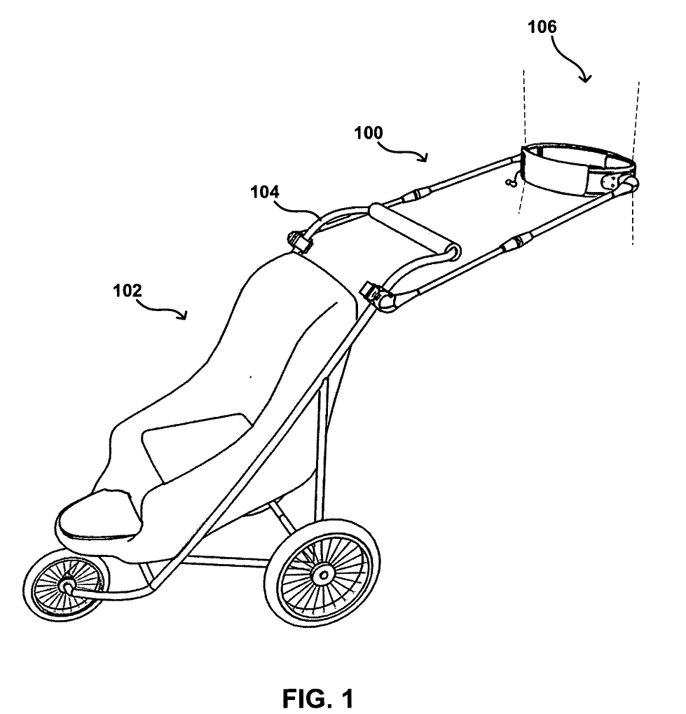

Systems and methods in accordance with various embodiments of the invention can overcome these and other deficiencies in existing approaches for connecting an operator to a manually-controllable vehicle in order to provide hands-free control of the vehicle. A control device 100 in accordance with one embodiment of the present invention is shown in FIG. 1 to connect between the torso of an operator 106 and a support member 104, such as a handlebar, of a manually-controllable vehicle 102.

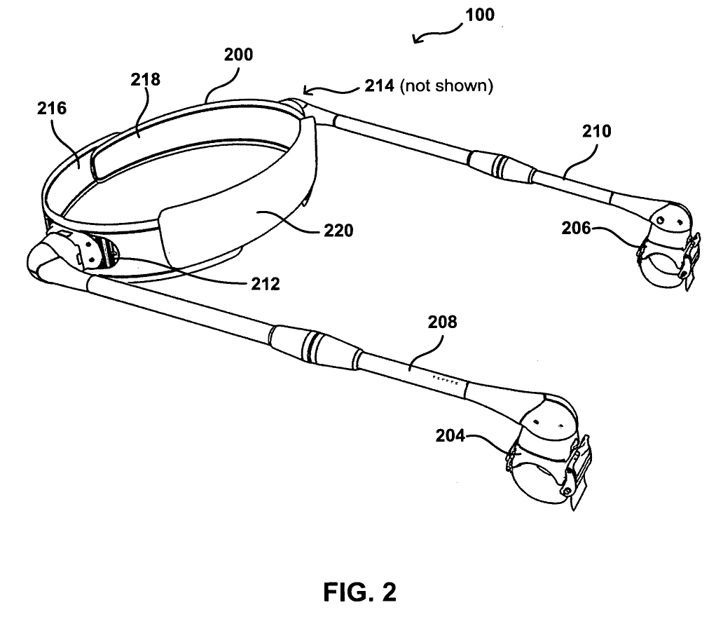

FIG. 2 shows an enlarged version of the connection device 100 of FIG. 1. This device is shown to include seven basic elements: a belt 200, which can be similar to a belt or fitness belt, shaped to fit around the torso of an operator of the vehicle, a pair of vehicle anchors 204, 206 operable to be attached by hand to a support member of the vehicle, a pair of belt anchors 212, 214 designed to attach to, connect to, or be formed as part of the belt 200, and a pair of control poles 208, 210 designed to be connected by hand to the vehicle anchors 204, 206 and belt anchors 212, 214 in order to connect the operator to the vehicle.

The belt 200 in the embodiment of FIG. 2 can be a solitary unit, consisting of a single piece of material, or can include a number of sections 216, 218, 220 as shown in FIG. 2. The belt can be formed from a soft, flexible, and/or durable material, such as leather, vinyl, or nylon, that is capable of conforming to the shape of the operator. The belt can be designed to fit around the waist and/or torso of an operator, and can have a length that can fit a range of operator sizes. The belt can include left and right sections 216, 218 that are designed to overlap, as is known in the art in order for a belt to accommodate the range of sizes, with a suitable fastening mechanism allowing the sections to be connected while allowing for varying amounts of overlap. While fastening mechanisms such as belts or snaps can be used, it can be desirable to use a mechanism such as VELCRO® brand hook and loop fasteners, available from Velcro Industries B.V. of Manchester, N.H. Such a connection mechanism allows an operator to easily and quickly get into, and out of, the belt, while the lack or rigid buckles or snaps can provide maximum comfort for the operator. Each of the left and right sections can be connected to the front section 220 using any appropriate fastening mechanism, which can be the same as, or different than, the fastening device used to connect the left and right sections. Belts also can come in different sizes, such as a small belt having a total length of around 980 mm and a total width of about 70 mm, as well as a large belt having a total length of around 1300 mm and a total width of about 100 mm.

An advantage to having the belt formed from sections is that the user can adjust the relative placement of front and side (right/left) sections so that the placement of the belt anchors 212, 214 can be adjusted to positions of maximum comfort for the operator, while allowing the operator to adjust the front section 220 to a position that is most comfortable for the stomach/chest area of the operator. Allowing for adjustment of the belt anchor positions also allows the operator to adjust the position at which the control poles 208, 210 connect to the belt, in order to allow the operator to obtain maximum control over the vehicle.

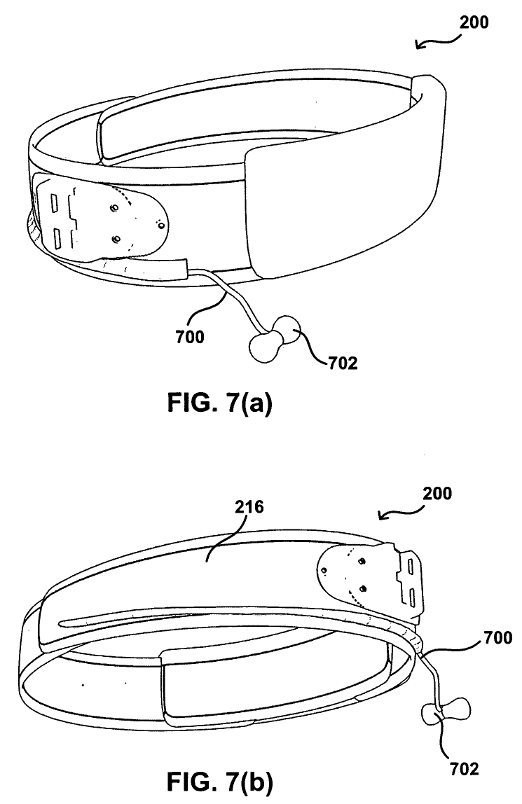

The belt 200 can include a safety ripcord 700 as shown in FIG. 7, in order to ensure quick detachment of the belt from the operator in case of an emergency. The ripcord can run along the inside of one of the side sections 216 of the belt, such as the right side, and can be stitched or otherwise attached near the overlapping portion at the back of the belt. The ripcord can be activated when the operator grabs an end of the ripcord, such as a plastic loop, handle, or other activation device 702 located at the front or sides of the belt. Such a loop can be designed to be readily seized by a finger or hand of the operator. An extension of the ripcord can be placed elsewhere to allow for easy and quick access, such as by attaching the extension to a shirt, sleeve, or band on the operator in a location where the user will not have to think about, or search for, the ripcord. The safety ripcord can ensure that the momentum of the operator in a fall or other undesirable situation will not cause the vehicle to take a similar dangerous turn or movement.

The belt also can be designed to include various other features that can be convenient for the operator. For instance, the side sections can include pocket, cords, buttons, Velcro®, and/or other mechanisms capable of carrying personal affects of the operator, such as a cellular phone, pacifier, water bottles, money, or any other required materials. Any of the sections can include zippers, snaps, or other features for closing a pocket or flap, ensuring that items such as keys are not lost during movement.

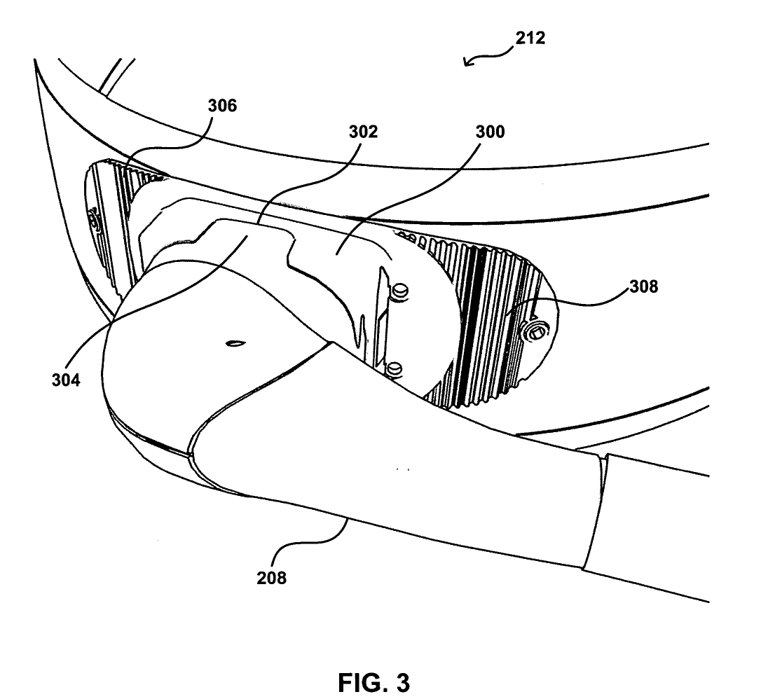

Each of the side sections of the belt 200, or opposing sides of the belt on an operator when the belt is a single piece, can have attached one of the belt anchors 212, 214. An exemplary belt anchor 212 is shown in more detail in FIG. 3. Having the belt anchors at the sides of the operator can provide enhanced steerability. Further, such an embodiment avoids the application of pressure by the control poles on the stomach area of the operator, as the force can be applied at the sides of the belt and distributed across the front of the belt, which applies a more even force to the front of the user than if the two control poles pushed directly on the front of the user as in existing designs. Each such anchor includes a locking mechanism 300, such as a bracket, bracelet, plastic joint, rigid channel, or clip, shaped to connect with a portion of one of the control poles 208. In this example, the locking mechanism 300 includes a plastic housing including a groove 302 therein for receiving a locking member, here a plastic tongue 304, of the control pole. Although these components are described to be plastic, any other appropriate material such as stainless steel or aluminum could be used as well. This locking mechanism is connected to, or formed along with, a pair of wing extensions 308, which can serve a number of purposes. First, each wing extension contacts a larger surface area of the belt, such that pressure can be more evenly distributed along the body of the operator, and any blunt edge of the locking mechanism is prevented from cutting into the side of the operator. Further, the longer contact area can more easily transfer body motion unto the control pole, allowing for increased ease in steering the vehicle, as the relative lateral motion of the control poles can be used to control the direction of the vehicle. Finally, if the mechanism is adhered to the belt, instead of stitched or otherwise mechanically connected, this design provides a larger area for adhesion. These wing extensions can have other functions, such as allowing an adjustment in positioning, a changing, and/or a rotation of the locking mechanism. The wing extensions can be flexible, and/or can be molded or otherwise formed to substantially match the shape of the operator.

The locking mechanism 300 can allow for a snap-in or pressure locking of the tongue portion 304 of the control pole 208. The control pole 208 then can be released by snapping-out the tongue, or by pressing a release button or lever as described below. Other mechanisms can be used as well, such as snapping an extension portion of the control pole into a receiving portion, clipping the pole into the locking mechanism, or threadably connecting the control pole to the locking mechanism. These mechanisms may not provide the ease of use and sturdiness of a slide-in locking channel, however.

The belt anchors can be ergonomically designed to be of minimal obstruction to the operator. The wing extensions, which can alternatively be part of the locking mechanism itself, can be formed of corrugated plastic in order to comfortably mold around the hips of the operator while providing a section for the mechanism to be riveted firmly onto the belt.

A vehicle anchor can be used at the other end of each control pole to attach the pole to a support member of the vehicle. Each vehicle anchor 204, 206 in this embodiment can include a locking mechanism 400, which can include a groove 402 to lockably receive a tongue portion of a control pole 208. The groove 402 can be the same size and shape as the groove of the belt attachment mechanism, such that the tongue at either end of the control pole can slidably lock into the groove 402. In other embodiments, the locking mechanism approach of the belt attachment mechanism can be different than the locking mechanism approach of the vehicle attachment mechanism, and can include any of the mechanisms discussed above. For the vehicle anchors, however, the locking mechanism can be attached to at least one conformable member, such as a strap 404, shaped member, or other similar device, capable of tightly wrapping around, clamping to, or conforming in shape to a support member of the vehicle in order to apply securing pressure, thereby securably and releasably fastening the vehicle anchor to the support member. As shown in this embodiment, the strap 404 can have a loop 406 at a first end designed to fit within a securing strap lip 408 of the attachment mechanism. The other end of the strap contains a clasp or levering mechanism 410 that allows the strap 404 to be tightly connected around the support member when the loop 406 is positioned in the lip 408. The strap can be tightened by hand simply by pressing the lever 410 into a locked position. The strap also can be tightly attached through other mechanisms, such as a buckle or clasp at the otherwise unattached end of the strap. The strap can include a length adjustment section 412 allowing the strap to be adjusted to tightly fit the respective support member. Properly adjusting the length of the strap can prevent any slipping of the strap on the support bar. The portion 414 of the anchor that contacts the support member also can have a material, such as rubber, disposed thereon that can prevent slipping of the anchor with respect to the support member. Using a compressible or elastic material such as rubber can be advantageous as the lateral tightening of the strap can compress the rubber into the support member, thereby applying additional force directly to the support bar. The rubber piece used to prevent slipping can come in a number of sizes, in order to accommodate a wider range of support members. Additional rubber pieces can be used at other locations, such as under each strap, in order to prevent slippage and provide a tighter fit for various embodiments. This additional flexibility can allow a properly designed control device to connect to any appropriate vehicle.

An embodiment utilizing such a strap has an advantage in that the operator (or other person assembling the attachment) can fasten the vehicle attachment to the support member without the need for any external tooling, such as a screwdriver or allen wrench. The operator also can remove the anchor simply by releasing the strap, such as by moving the lever to an unlocked position. The vehicle anchors can be placed on opposing vertical support bars, as shown in FIG. 1, which can provide an increased amount of steerability. In order to adapt to other vehicles, it is possible to attach the vehicle anchors to a horizontal bar, but there can be problems with steerability due to the 360° rotation of the control bars relative to the anchor in that direction. Therefore, various embodiments can include pins, stops, or other rotation barriers that can be moved into place or activated in order to prevent rotation and provide sufficient steerability. The vehicle anchors also can placed on angled support members or shaped support members, depending upon the size and shape of the vehicle, as well as the size, shape, and comfort of the operator. The control poles can have at least one rotatable portion, as discussed below, allowing the ends to be rotated with respect to each other, such that the vehicle anchors can be placed at any appropriate location on the vehicle. The straps can be made of any appropriate material, such as leather, vinyl, or nylon. The length of the strap can vary to lengths generally in the range of about 1 to 5 inches, with the length largely being determined by the circumferential size of the support member. Once the vehicle anchors are attached to the support member, the anchors can be left in place or removed as necessary. Since the control poles can snap easily into place, it can be desirable for the user or operator to leave the anchors on the vehicle and simply remove the poles when not using the control device.

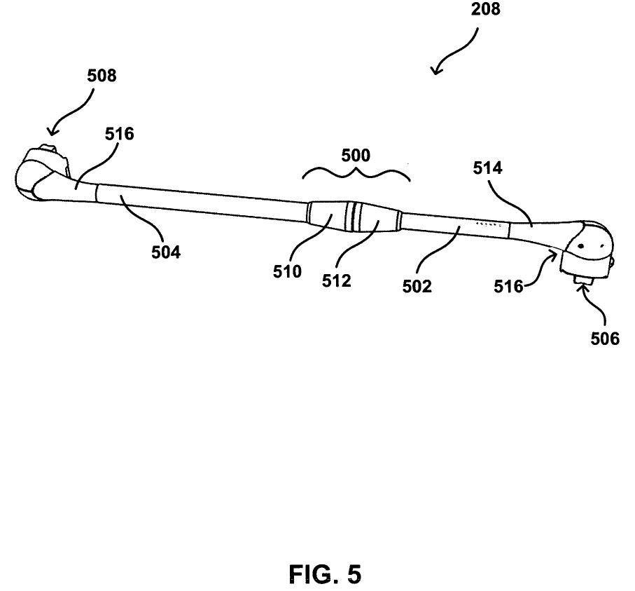

Between each vehicle anchor and belt anchor can be placed a control pole. Each control pole 208, 210 in the embodiment of FIG. 2 can have at least one rotatable portion allowing either pole to be adjusted to connect to either side of the belt and any location of the vehicle anchors. The ability for the control poles to partially rotate also allows for the respective vehicle anchor to be positioned on a vertical, horizontal, or angled support member. The rotation can be about a central axis of the control pole. In at least one embodiment, the point of rotation can be included in a telescopic assembly 500 as shown in FIG. 5. It can be seen that this control pole includes a first section 502 and a second section 504. The first section of the pole can be identical to the second section of the pole, including the connection assembly 506, 508 at each end for connection with one of the vehicle or belt anchors. In an alternative embodiment, one of the first and second sections can have a smaller diameter, such that one of the sections can slide into the other section in order to collapse the control pole. The telescopic assembly can include a tightening portion 510 that can be rotated by hand in one direction about a central axis of the control pole to loosen the telescopic assembly, such that an extension portion of the telescopic assembly 512, which can be approximately the same diameter as the cylindrical portions of the control pole, can be pulled out of, or pushed into, the tightening portion in order to adjust the overall length of the control pole. The ability to adjust the length allows the vehicle to be placed at a position relative to the operator that is comfortable for the operator, allowing for variations such as arm and leg length.

When the telescopic assembly 500 is loosened, the front and/or back section can be rotated with respect to the other section in order to fit the appropriate support member of the vehicle to be attached. Once the length and rotation of the control pole is as desired, the tightening portion 510 can be rotated in a second direction about the central axis to tighten the telescopic assembly 500, such that the sections of the control pole cannot move or slip with respect to one another. Threaded and other assemblies for connecting cylindrical (or other) members are known in the art and will not be discussed in detail herein. The assemblies can be made of any appropriate material, such as plastic or aluminum, and can have undulations on the outside of the tightening portion in order to facilitate rotation by hand. While the poles are discussed with respect to cylindrical poles, it should be understood that the poles can include elongated members of any appropriate shape, and can include bends or other adjustable shapes where appropriate.

The extension portion 512 of the telescopic assembly 500 can include a cylindrical extension portion and an extension housing. The extension portion can be resiliently attached inside the extension housing, such that the extension portion can undergo a limited amount of axial movement inside the extension housing. The extension portion can be biased to a certain position, such as by a spring or resilient member, such that only a rapid and/or forceful movement of the extension portion will cause movement of the extension portion with respect to the extension housing. This connection provides a level of shock absorption, as well as preventing the operator and/or vehicle from being uncomfortably tugged backward or forward during operation, as the control poles are each able to adjust to the sudden movement. In other embodiments, the extension portion can be locked into place during certain operation, such as running, in order to maximize control over the vehicle. The extension portion then can be released at a later time to allow the poles to slide into one another, such that the operator can be more comfortable during operations such as leisurely walking. For instance, when the operator turns to the right, whereby the right hip goes forward and the left hip goes back, the poles can absorb the opposite direction of the hips to prevent an uncomfortable motion for the operator.

Each section 502, 504 of the control pole can have a resilient portion 514, 516 allowing for a controlled amount of flexibility, compressibility, and elasticity in the control pole. For instance, the end of the control pole attached to the belt can be allowed to flex up to a maximum flexure tolerance in order minimize stresses, due to movements such as swaying of the hips of the operator during walking or jogging, while still providing adequate steerability. This ability to flex also can reduce pressure on the overall system, which can help to prevent breakage or other damage. The resilient portions also can serve another important function, namely that of shock absorption. Using a compressible, expandable material such as rubber or silicone can allow for the absorption of a significant amount of shock being transferred between the vehicle and the operator, particularly when a user is jogging and could induce an undesirable amount of shock to a user of the vehicle with each step. The ability of the control poles to absorb pressure also can help protect the operator from injury and provide a more comfortable ride for the passenger of the vehicle. The resilient portions can be made of any appropriate material capable of absorbing pressure while providing a sufficient amount or rigidity. The length of each resilient portion also can be selected to balance the amount of flexibility with the amount of rigidity of the control pole, such as a length of about 8 cm.

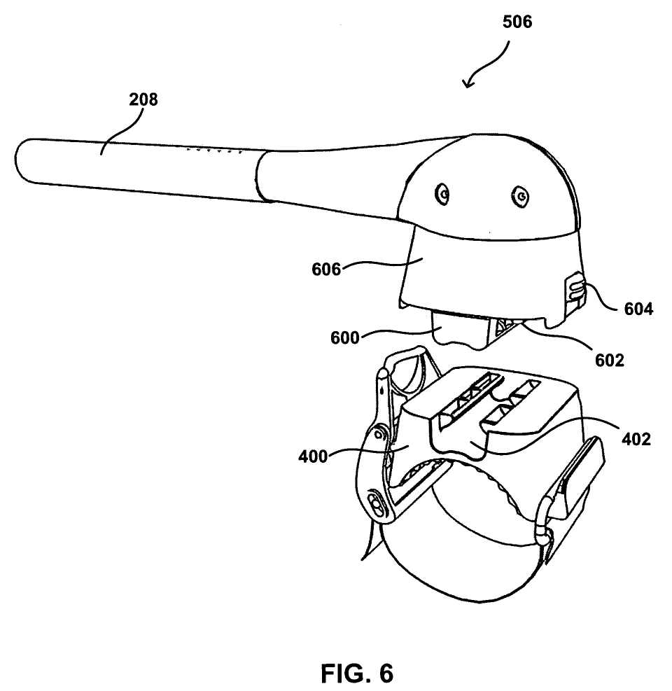

As discussed above, each section of the control pole 208 can have a connection assembly 506, 508 designed to connect with any vehicle or belt anchor. A magnified view of one of these connection assemblies 506 is shown in FIG. 6. In this embodiment, the connection assembly is shown to include a protruding tongue 600 shaped to be received by a corresponding groove 402 in one of the anchors 400. The groove is formed with an open end such that the tongue 600 can be slid into the groove from an open end of the groove 402. This connection assembly also includes a retractable latching mechanism 602 that is spring biased to be in an extended position. This latching mechanism 602 is designed to retract while the tongue is being slid into place in the groove 402, then extend into a recess (not shown) in the groove in order to “lock” the tongue in place, preventing the control pole 208 from inadvertently disengaging from the anchor 400. The connection assembly 506 also includes a release button 604, release switch, or other release mechanism that, when activated by hand, retracts the latching mechanism 602 from the recess such that the tongue can be slidably removed from the channel, in order to remove the control pole from the anchor. These components can be made of any appropriate material, such as plastic, metal, or aluminum, and there may be other latch and release designs that can be used to allow the tongue 600 to be releasably secured into the corresponding groove 402. A major advantage of such a design is that the control poles can be attached and removed from the vehicle and/or belt by hand, without the need for external tooling such as wrenches or screwdrivers.

The control pole also includes a housing 606 that allows for 360° rotation of the control pole at the location 518 where the connection assembly 506 meets the elongated portion of the control pole 208. The mechanism for rotation can include a ball and socket or rod connection, for example, that allows for rotation of the elongated portion with respect to the housing. This rotation allows for the angle of the control pole to be adjusted to fit the particular operator and/or vehicle. This rotation also allows for movement of the operator (in a plane orthogonal to the axis of rotation) without imparting significant movement (in that plane) unto the vehicle. This can be beneficial as the torso of the operator can tend to move up and down while walking/running, and it can be desirable to transfer only the forward motion of the operator unto the vehicle. If the connection assemblies are attached to a horizontal support member, then the amount of horizontal motion that is transferred can be reduced.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

We claim:

1. An apparatus for connecting an operator to a moveable vehicle, comprising:
first and second vehicle anchors each including a conformable member operable to be secured by hand about a support member of the moveable vehicle in order to supply securing pressure between the respective anchor and the support member;
a belt operable to be fastened about a torso of the operator;
first and second belt anchors operable to securely fasten to the belt, the first and second belt anchors being positioned at substantially opposing sides of the operator when the belt is fastened to the operator; and
first and second telescopic control poles, each telescopic control pole having connection assemblies at each end of the respective control pole, each connection assembly shaped to removably lock into position in one of the first and second vehicle anchors or one of the first and second belt anchors in order to connect the belt to the moveable vehicle, each telescopic control pole having a resilient portion at each end providing flexibility of the telescopic control pole, each resilient portion further being compressible in order to provide shock absorption between the belt and the moveable vehicle.

2. An apparatus according to claim 1, wherein:
the support member includes a handlebar, and each vehicle anchor is operable to connect to one of a horizontal, vertical, and angled region of the handlebar.

3. An apparatus according to claim 1, wherein:
the support member includes two opposing vertical bars of the moveable vehicle.

4. An apparatus according to claim 1, wherein:
each telescopic control pole includes a housing allowing for 360 degree rotation of the respective telescopic control pole.

5. An apparatus according to claim 1, wherein:
the belt includes a plurality of connectable sections, allowing the operator to adjust a shape of the belt.

6. An apparatus according to claim 1, further comprising:
a safety ripcord running along a portion of the belt allowing the operator to quickly detach the belt.

7. An apparatus according to claim 1, wherein:
the belt includes at least one operator convenience feature selected from the group consisting of pockets, cords, buttons, and pouches.

8. An apparatus for connecting an operator to a moveable vehicle, comprising:
a vehicle anchor operable to fasten to a support member of the moveable vehicle, the vehicle anchor including a first locking mechanism and a conformable member operable to be securely fastened about the support member by hand, in order to releasably fasten the vehicle anchor to the support member;
a belt configured to fasten about a torso of the operator;
a belt anchor operable to securely fasten to the belt, the belt anchor including a second locking mechanism; and
a control pole having housings at each end, the housings each having a locking member shaped to be received by one of the first and second locking mechanisms in order to connect the belt to the moveable vehicle.

9. An apparatus according to claim 8, wherein:
the vehicle anchor further includes a hand-operable latching member adapted to securely fasten the conformable member to the vehicle anchor.

10. An apparatus according to claim 8, wherein:
each of the first and second locking mechanisms includes a slide lock adapted to slidably receive the locking member of the control pole.

11. An apparatus according to claim 8, wherein:
each of the first and second locking mechanisms includes a hand release assembly allowing the control pole to be removed from the respective locking mechanism.

12. An apparatus according to claim 8, wherein:
the control pole includes a telescopic member that is adjustable in order to select a length of the control pole.

13. An apparatus according to claim 8, wherein:
the control pole includes at least one resilient portion allowing for flexing of the control pole and providing shock absorption between the belt and the moveable vehicle.

14. An apparatus according to claim 8, wherein:
each housing allows for 360 degree rotation of the respective control pole.

15. An apparatus for connecting an operator to a moveable vehicle, comprising:
a vehicle anchor operable to securely fasten to a support member of the moveable vehicle;
a belt operable to fasten about a torso of the operator;
a belt anchor operable to securely fasten to the belt; and
a control pole having housings at each end operable to connect to one of the vehicle anchor and belt anchor in order to connect the belt to the moveable vehicle, each control pole having at least one resilient portion allowing for movement of the control pole with respect to the vehicle anchor and belt anchor, each resilient portion further operable to provide shock absorption between the belt and the moveable vehicle.

16. An apparatus according to claim 15, wherein:
the control pole includes a telescopic member that is adjustable in order to select a length of the control pole.

17. An apparatus according to claim 16, wherein:
the telescopic member is resiliently telescopic in order to absorb shock along the control pole.

18. An apparatus according to claim 15, wherein:
the resilient portion includes a rubber section of the control pole.

19. An apparatus according to claim 15, wherein:
the control pole includes a resilient portion near each end of the control pole, allowing the control pole to flex with respect to the vehicle anchor and belt anchor.

20. An apparatus according to claim 15, wherein:
each housing allows for 360 degree rotation of the respective control pole.
